(19) United States
(12) Patent Application Publication
(10) Pub. No.: US 2023/0305235 A1
(43) Pub. Date: Sep. 28, 2023

(54) OPTICAL MULTI-COUPLER WITH CORRECTING ELEMENT AND PRODUCTION METHOD FOR THIS PURPOSE

(71) Applicant: HUBER+SUHNER Cube Optics AG, Mainz (DE)

(72) Inventors: Ingo SMAGLINSKI, Mainz (DE); Thomas PETIGK, Rüsselsheim (DE)

(73) Assignee: HUBER+SUHNER Cube Optics AG, Mainz (DE)

(21) Appl. No.: 18/124,937

(22) Filed: Mar. 22, 2023

(30) Foreign Application Priority Data
Mar. 24, 2022 (DE) 102022107005.0

(51) Int. Cl. G02B 6/32; G02B 6/293; G02B 6/35

(52) U.S. Cl. CPC G02B 6/32; G02B 6/2938; G02B 6/3504

(57) ABSTRACT

A multi-coupler has a first group of optical sending elements and a second group of optical receiving elements. To provide an optical multi-coupler that poses lesser demands for the positioning and orientation of the individual elements and still can map the optical signals provided by the optical sending elements to the optical receiving elements in a highly precise manner, a correcting element is positioned and configured between an optical sending element and an optical receiving element such that the distance between focal point and optical receiving element is reduced by the correcting element.

The present invention relates to a multi-coupler having a first group of optical sending elements and a second group of optical receiving elements, wherein either the first group or the second group comprises more than two elements. Each optical sending element is associated with a transmitting element, which is configured and arranged such that a divergent beam bundle emanating from the optical sending element is converted into a convergent beam bundle and diverted to an optical receiving element. The convergent beam bundle converges in a focal point.

An example of such a multi-coupler is an optical multiplexer or demultiplexer.

The so-called wavelength multiplexing method, which represents an optical frequency multiplexing method, is generally used for the transmission of signals to fibre optic. In the multiplexing method, light signals having different frequencies are used for the transmission. Each frequency used provides its own transmission channel to which the actual data to be transmitted can be modulated. The data signals modulated in this manner are then bundled by means of respective optical coupling elements and transmitted simultaneously, but independently of one another. At the receiver of this optical multiplexed link, in a demultiplexer, the individual optical transmission channels are then separated again using respective passive optical filters and converted into electrical signals with corresponding sensor elements.

Optical multiplexers and demultiplexers have long been known. Generally, a multiplexer can also be used as a demultiplexer by reversing the beam path and vice versa. Instead of sensors, which generate the respective light signals to be transmitted, only lasers need be used, which convert the transmitted optical signals into electrical signals. Reference to a demultiplexer is therefore often made below. However, it will be appreciated that the described features of a demultiplexer can also be applicable to multiplexers, wherein the beam direction is simply reversed.

Generally, demultiplexers comprise an optical sending element, which can consist of, for example, a fibre optic via which multiple signal channels are transmitted. A divergent beam bundle is then emanated from the end of the fibre optic, which is transmitted to multiple optical receiving elements by a suitable sending element. In principle, all devices that can receive and/or evaluate optical signals, such as light sensors, waveguide ends, or grid couplers, are considered optical receiving elements.

For example, the divergent beam bundle can first be converted into a substantially parallel beam bundle, which is then passed sequentially through specially arranged optical filters, each allowing a section of the signal channels to pass through while reflecting a different section of the signal channels. Such an arrangement is also known as a filter cascade and is typically configured such that each optical filter separates a wavelength channel from the remaining signal. The separate channels are then also present as parallel beam bundles and are then directed through corresponding focussing elements to the optical receiving element provided for the respective signal channel. For example, if six signal channels are transported over the fibre optic at the same time, the corresponding multiplexer comprises one optical sending element and six optical receiving elements.

It is understood that an optimal signal sensing will only occur when all elements are arranged and aligned exactly to one another. In the production of such demultiplexers, but also in other optical multi-couplers, a relatively large effort is therefore made to position the individual elements very precisely to one another. Despite the greatest effort, this is not always possible, so that a small proportion of produced products cannot achieve the desired specifications and can be classified as a rejection.

It is usually already sufficient that only a single element used in the optical multi-coupler is not positioned precisely enough, so as to render the entire optical multi-coupler unusable.

Thus, against the background of increasing complexity of multiplexers and demultiplexers due to a variety of additional channels, which results in an increase in the elements used in the optical multi-coupler, the rejection rate automatically increases.

In order to meet the increased requirements for the exact positioning and alignment of each individual element in an optical multi-coupler, a much higher effort must therefore be expended, which is in practice hardly feasible and leads to an increased rejection rate despite all efforts.

Against the background of the described prior art, the problem addressed by the present invention is therefore to provide an optical multi-coupler that poses lesser demands for the positioning and orientation of the individual elements and still can map the optical signals provided by the optical sending elements to the optical receiving elements in a highly precise manner. The problem of the present invention is also to specify a method that allows optical multi-couplers to be set very precisely with little effort.

According to the present invention, this problem is solved in that a correcting element is positioned between an optical sending element and an optical receiving element and is configured such that
i) the distance between the focal point and the optical receiving element is reduced by the correcting element,
ii) the angle at which the convergent beam bundle impinges on the optical receiving element is changed,
iii) the polarization state of the convergent beam bundle is changed, or
iv) the field shape of the convergent beam bundle is changed.

In other words, faults in the system due to inaccurate positioning and arrangement of individual elements of the optical multi-coupler are corrected using the correcting element. In addition, deviations due to production tolerances of the component used can be corrected very easily.

A misalignment or misorientation of one or more elements of the optical multi-coupler can result in the focal point no longer lying exactly on the optical receiving element or the convergent beam not having the desired angle on the optical receiving element. In addition, the polarization state of the convergent beam bundle may not correspond to the desired polarization state. Also, the field shape of the convergent beam bundle, i.e. the intensity distribution in a sectional view perpendicular to the propagation direction of the convergent beam bundle, may not be homogeneous or may not correspond to the desired field shape.

In all such cases, which can also occur simultaneously, the misalignment can be corrected by providing a correcting element between an optical sending element and an optical receiving element. Optical multi-couplers that do not meet their requirements and have thus been considered as rejects so far can be reused with the aid of the correcting element. Moreover, the requirements for the exact positioning and orientation of the elements can be reduced, because any misalignments that can occur are corrected by the provision of a correcting element.

This can significantly reduce production costs as a result.

In a preferred embodiment, it is provided that the transmitting element comprises at least a first collimator and at least a second collimator, wherein a first collimator is associated with each optical sending element, which is configured and arranged in such a way that the first collimator converts a divergent beam bundle emanating from the optical sending element into a parallel beam bundle. Furthermore, each optical receiving element is associated with a second collimator, which is configured and arranged in such a way that a beam bundle directed from the first collimator to the second collimator is converted into a convergent beam bundle and diverted to the respective optical receiving element.

Thus, a divergent beam bundle exiting from an optical sending element is converted by the associated first collimator into a parallel beam bundle and optionally transmitted to a second collimator via one or more optical filters and converted by said collimator into a convergent beam bundle that is diverted towards the optical receiving element associated with the second collimator.

The number of first collimators preferably corresponds to the number of optical sending elements, while the number of second collimators corresponds to the number of optical receiving elements.

In a further preferred embodiment, it is provided that multiple first collimators and/or multiple second collimators are joined together in a material-locking manner, wherein multiple first collimators and/or multiple second collimators are preferably formed from one material piece.

For example, after the arrangement of sending elements and receiving elements as well as the arrangement of the transmitting elements, a test can be performed in order to draw conclusions about the position of the focal point, the angle at which the convergent beam bundle impinges on the optical receiving element, the polarization state of the convergent beam bundle, and/or the field shape of the convergent beam bundle. The test result is then compared to the respective desired values and a corresponding correcting element is then created, which, when positioned in the correct position, brings the test value at least closer to the desired value.

The respective test values can be sensed immediately from multiple transmitting elements and then multiple correcting elements can be produced together and positioned accordingly, such that, in particular when a large number of optical receiving elements are used in the optical multi-coupler, by positioning only one correcting component which includes all correcting elements, the optical multi-coupler can be produced in a significantly more time-saving manner and thus less expensive.

In a further preferred embodiment, it is provided that multiple first collimators and/or multiple second collimators are configured as curved reflective surfaces. It is particularly expedient when the reflective surface has approximately the shape of a section of a rotational paraboloid, a rotational ellipsoid, or a rotational hyperboloid. In other words, the reflective surface follows the outer surface of a rotational body, at least piecewise. This results in a section through the reflective surface along a cutting surface perpendicular to the axis of rotation having approximately a circular section shape, while a section along a plane in which the axis of rotation lies is approximately the shape of a section of a parabola, hyperbola, or ellipse. Such a curved reflective surface has particularly suitable mapping properties.

In a further preferred embodiment, the correcting element comprises an entry surface and an exit surface and is positioned between an optical sending element and an optical receiving element such that the beam bundle enters the correcting element via the entry surface and exits the correcting element via the exit surface. Alternatively, the correcting element could also be configured as a mirror.

For example, the correcting element can be a prism, wherein the entry surface and the exit surface are preferably not arranged parallel to one another.

The entry surface of the prism and/or the exit surface of the prism can be curved in configuration.

Furthermore, the correcting element can be a lens.

In principle, the correcting element can be arranged at any position between an optical sending element and an optical receiving element. In a preferred embodiment, however, it is provided that the correcting element is arranged between a first collimator and a second collimator. Between the first collimator and the second collimator, the beam bundle is substantially parallel.

The optical multi-coupler can be configured as a multiplexer/demultiplexer. In a further preferred embodiment, the optical multi-coupler is configured as an optical rotary transmitter. Such a rotary transmitter is used in order to transmit optical signals between units that are rotated relative to one another. They are therefore also called rotary couplers or rotary transmitters.

In a further preferred embodiment, it is provided that the correcting element comprises a main section and a subsequent compensation section, wherein the main section comprises the entry surface and the compensation section comprises the exit surface, wherein the main section consists of a material having a first refractive index and the compensation section consists of a material having a second refractive index, wherein the first and second refractive indexes are different.

With this measure, the optical multi-coupler will only depend slightly on the correct positioning of the correcting element, so that no increased requirements for the correcting element and its positioning need be posed.

In a preferred embodiment, an interface between the main section and the compensation section is not configured parallel to the entry surface, but the exit surface preferably runs parallel to the entry surface.

Furthermore, a correcting component can be provided, which comprises a plurality of correcting elements, such that by positioning the correcting component, multiple correcting elements are correctly positioned.

The aforementioned problem is also solved by a method for producing an optical multi-coupler, having the following steps:
A) Arranging
i) a first group of optical sending elements,
ii) a second group of optical receiving elements, wherein either the first group or the second group comprises more than two elements, and
iii) one or more transmitting elements, so that
a) each optical sending element is associated with a transmitting element, and the transmitting element converts a divergent beam bundle originating from the optical sending element into a convergent beam bundle,
b) and the convergent beam bundle is diverted to an optical receiving element and the convergent beam bundle converges in a focal point,
B) emitting beam bundles from at least one and preferably all sending elements of the group of optical sending elements,
C) sensing the position of the focal points of at least one and preferably all transmitting elements and/or sensing the direction of at least one and preferably all converging beam bundles and/or sensing the polarization state of at least one and preferably all converging beam bundles and/or sensing the field shape of at least one and preferably all converging beam bundles,
D) determining and producing at least one correcting element with the proviso that, after positioning the correcting element at a predetermined position between the at least one sending element and a receiving element associated therewith, the difference between the value detected in step C) and a predetermined TARGET value is less than prior to the positioning of the correcting element,
E) positioning the correcting element produced in step D) at the predetermined position.

Advantageously, at least a first collimator and at least a second collimator are used as the transmitting element, wherein
a) a first collimator is associated with each optical sending element, and the first collimator converts a divergent beam bundle originating from the optical sending element into a parallel beam bundle,
b) each optical receiving element is associated with a second collimator, and a beam bundle directed from the first collimator to the second collimator is converted into a convergent beam bundle and diverted to the respective optical receiving element, and the convergent beam bundle converges in a focal point, and
c) a beam bundle exiting from an optical sending element is transmitted from the associated first collimator to one of the second collimators and diverted to the optical receiving element associated with this second collimator,
   wherein, in step C), the position of the focal points of at least one and preferably all second collimators and/or the direction of at least one and preferably all converging beam bundles is sensed, and in step D), at least one correcting element is determined and produced with the proviso that, after positioning of the correcting element at a predetermined position between the at least one sending element and a receiving element associated therewith, the distance between the focal point of the second collimator associated with the receiving element and the receiving element is less than prior to the positioning of the correcting element and/or the deviation of the direction of the convergent beam bundle from a predetermined direction is less than prior to the positioning of the correcting element.

Furthermore, the present invention relates to a method for producing a correcting element that can be used in an optical multi-coupler as described above or in a method as described above. The method comprises the following steps:
1) providing a base body from a transparent material for a beam bundle to be transmitted,
2) heating a surface of the base body until the surface is no longer dimensionally stable,
3) pressing a punch into the surface of the base body, said punch having a mould surface that is configured as the negative to a desired surface of the correcting element to be produced,
4) cooling the surface of the base body until the surface is dimensionally stable,
5) bringing the mould surface out of engagement with the surface.

In order to produce the correcting element according to the invention, a punch is therefore produced which has a mould surface that is formed as the negative to the desired surface of the correcting element. In the simplest case, the surface of the correcting element is level but inclined towards a reference plane. In this case, the punch also has a planar mould surface, which however in step 3) is pressed onto the surface of the material in an inclined configuration. If the correcting element is to have a convex surface, the mould surface must be concave.

The following further developments of the method can be carried out altogether or in any combination with one another:

In step 1), the material can consist of two material sections. For example, a glass panel can be provided with a thermoplastic coating, such that in step 2) only the thermoplastic coating is heated until the coating transitions into the thermoplastic or liquid state.

In step 2), the heating can be carried out with the aid of a laser beam, which is preferably focused on the part of the surface that is to come into contact with the mould surface.

For example, the laser beam can be diverted into the material from the side facing away from the surface to be heated.

Step 3) can be carried out several times in a row when the transparent material is displaced from time to time so that the punch comes into contact with different surface portions. As a result, a correcting component comprising multiple correcting elements is created. Alternatively, the punch can also be moved laterally between two successive steps 3).

If step 3) is performed several times in a row, the angle at which the punch is oriented towards the surface of the material can be changed between operations. In successive pressing-in steps, different punches having different mould surfaces can also be used.

Further advantages, features, and possible applications of the present invention will become apparent from the examples shown in the following figures. The following are shown:

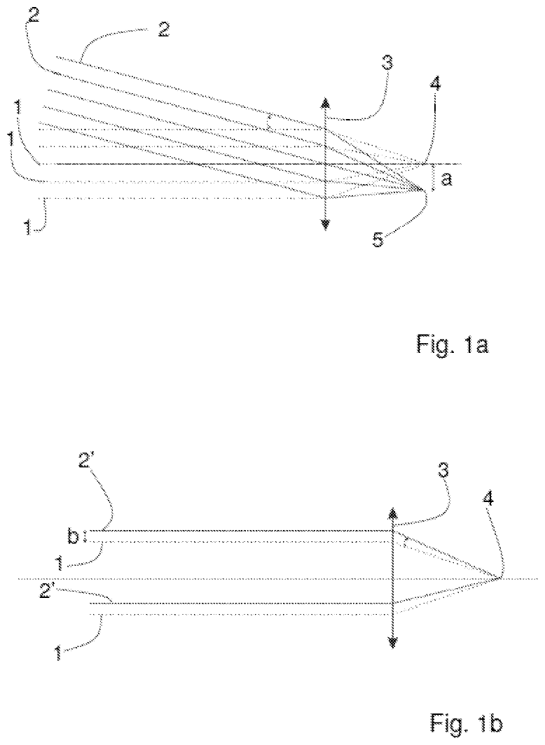

FIGS. 1a and 1b a schematic representation of various misalignments and their effects on the focal point,

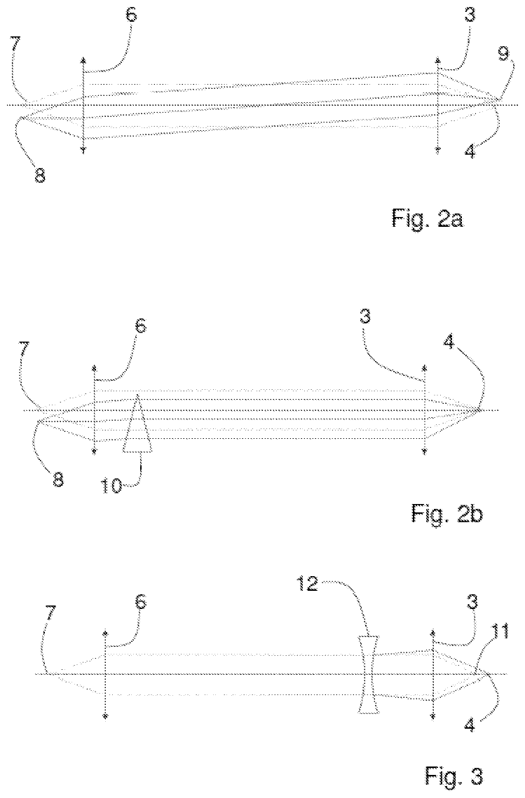

FIGS. 2a and 2b a schematic representation of the functionality of the correcting element according to the invention,

FIG. 3 a schematic representation of the course of a beam bundle with an alternative embodiment of the correcting element according to the invention,

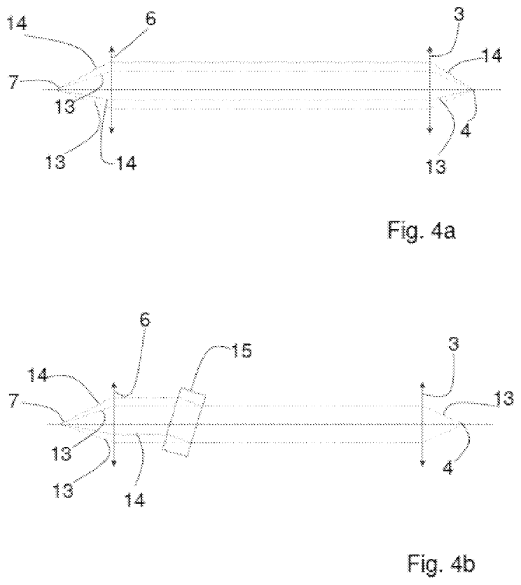

FIGS. 4a and 4b schematic representations of the course of the beam bundle with a further embodiment of the correcting element according to the invention,

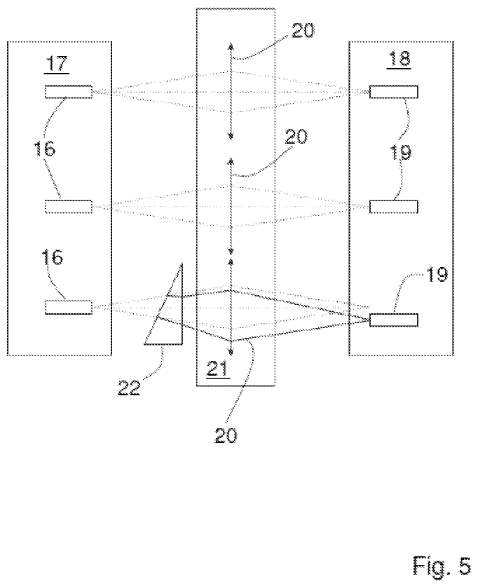

FIG. 5 a schematic representation of a first embodiment of a multi-coupler,

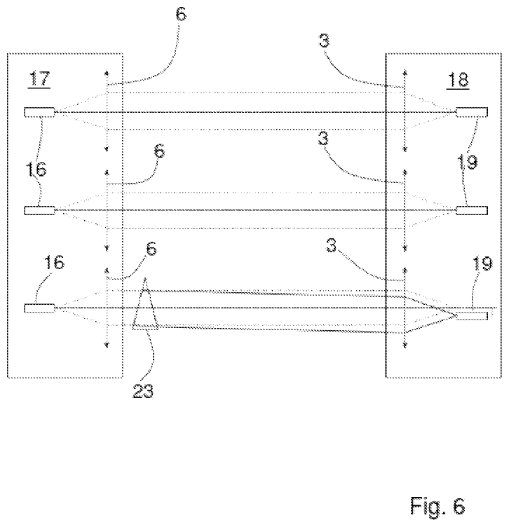

FIG. 6 a schematic representation of a second embodiment of the multi-coupler,

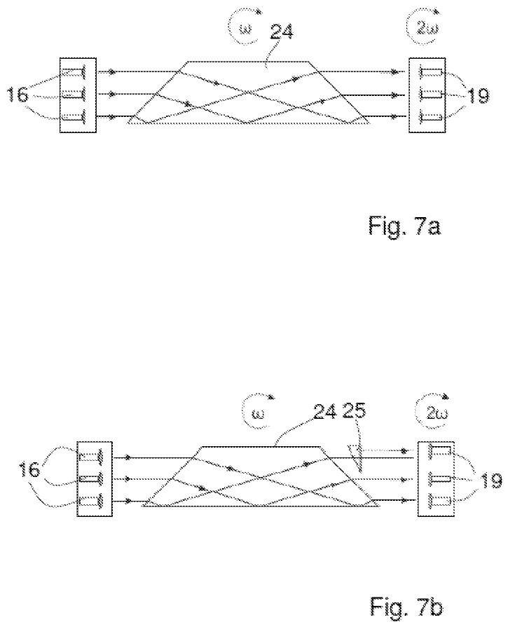

FIGS. 7a and 7b a schematic representation of a rotary coupler with and without the correcting element according to the invention,

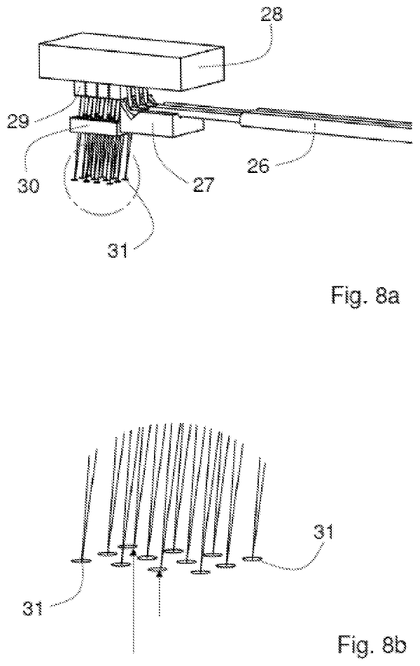

FIGS. 8a and 8b a multi-coupler of the prior art,

FIG. 9 a correcting element according to the invention,

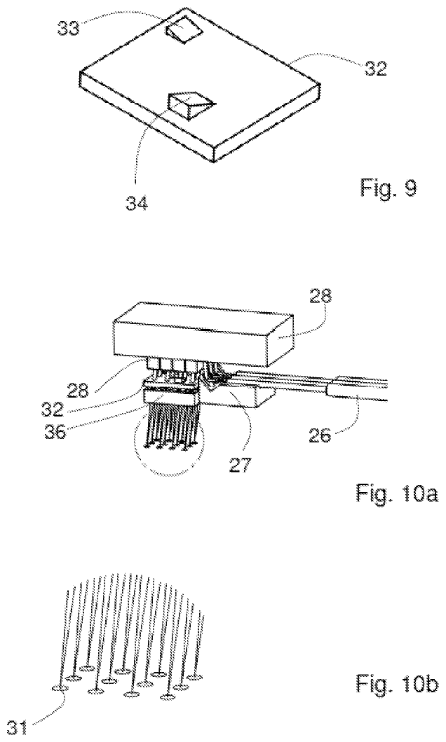

FIGS. 10a and 10b representations of the optical multi-coupler of FIGS. 10a) and 10b) with the correcting element according to the invention,

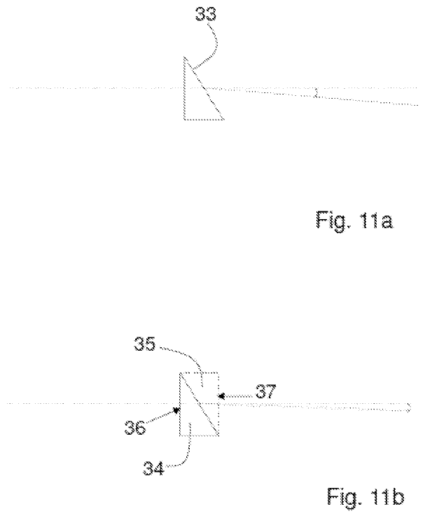

FIGS. 11a and 11b a schematic representation of a correcting element according to the invention with and without the compensation section, and

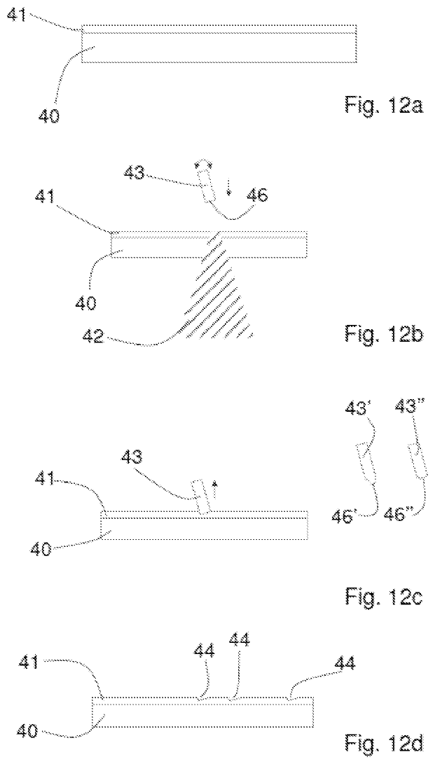

FIGS. 12a-d schematic representations of a method for producing a correcting element.

In FIG. 1, a parallel beam bundle 1 is shown, which impinges on a collimator 3, which converts the parallel beam bundle into a convergent beam bundle, which is focused in the focal point 4. The optical receiving element (not shown) must then be positioned in the focal point 4 in order to ensure optimal signal transmission.

Due to incorrect positioning and incorrect adjustments, however, it may be that the parallel light beam or beam bundle does not impinge as desired on the collimator 3, but rather tilts opposite the optimal direction of impingement. This is shown in FIG. 1a by the further parallel beam bundle 2. For clarity, the angular error is shown greatly exaggerated here. Due to the non-optimal impinging angle of the parallel beam bundle 2 on the collimator 3, the parallel beam bundle 2 is mapped to the focal point 5, which is spaced apart from the focal point 4 by the distance a. If the optical receiving element is now positioned at the position of the focal point 4, the light signal of the beam bundle 2 is not optimally transmitted.

In FIG. 1b, a parallel beam bundle 1 is also shown, which is focused again in a focal point 4 by the collimator 3. If the parallel beam bundle is now laterally shifted so that the parallel beam bundle 2′ impinges on the collimator instead of the parallel beam bundle 1, the latter is also focused on the focal point 4, but at a different angle, which can also lead to a non-optimal signal transmission.

The two examples clearly show that even small misalignments can lead to the signal no longer reaching the optical receiving elements or no longer reaching them at full signal strength.

FIG. 2a now schematically shows a structure comprising a first collimator 6 and a second collimator 3. The second collimator 3 focuses a parallel beam impinging perpendicular to the collimator surface 3 into a focal point 4. In order to generate this parallel beam, an optical sending element must be arranged at the position 7 and from there direct a convergent beam to the first collimator 6, which converts this divergent beam into a parallel beam.

If the optical sending element is now not arranged at the actually provided position 7, but rather laterally offset at the position bearing the reference number 8 and from there a diverging beam bundle is directed onto the first collimator 6, this leads, as can be seen in FIG. 2a, to the beam bundle being mapped by the second collimator 3 to a focal point 9, which is spaced apart from the focal point 4.

If this distance is too large, the optical multi-coupler cannot be used. It must therefore be ensured in the prior art that the optical sending element is precisely arranged at the position provided for it.

Instead of the exact positioning of the optical receiving element, as suggested according to the invention, a correcting element can instead be positioned in the beam path. In this case, as shown in FIG. 2b, a correcting element configured as a prism 10 is arranged between the first collimator 6 and the second collimator 3. The arrangement of the correcting element 10 changes the angle which encloses the parallel light beam with the first collimator 6 starting from the first collimator 6 such that the light beam impinges on the second collimator 3 at the desired angle of incidence and is thereby mapped in the focal point 4.

It can immediately be discerned that a small deviation of the position of the correcting element 10 has almost no effect on the focal point 4, so that it is much easier to position the correcting element 10 in the beam path than to position the optical sending element exactly at the intended position.

In FIG. 3, a further schematic representation of a beam path is shown. Again, a divergent beam bundle is transmitted from an optical sending element 7, which impinges on the first collimator 6 and is converted therein into a parallel beam bundle. This parallel beam bundle now impinges on the second collimator 3, which convergently maps the beam bundle into the focal point 11, which, however, lies ahead of the actually desired focal point 4 due to incorrect positioning.

In this case, a concave lens is used as the correcting element 12, which changes the profile of the parallel beam bundle such that it is mapped in the desired focal point 4.

In FIG. 4a, a further schematic representation of an optimal beam path and a faulty beam path is shown. The optimal beam path starts at the optical sending element 7 and is directed there as a divergent beam bundle 13 to the first collimator 6, then to the second collimator 3 and finally into the focal point 4. If, for any reason, the divergent beam bundle has a different direction so that it does not centrally impinge on the first collimator 6 and takes the course bearing the reference number 14, this will result in a section of the signal passing through exterior regions of the first collimator 6 and the second collimator 3 and then being mapped to the focal point 4 at a steeper angle. Both the steeper angle and the use of the exterior regions of the collimators have negative effects on signal transmission.

According to the invention, it is therefore provided that a glass plate 15 is placed in the beam path, as shown in FIG. 4b. The glass plate 15 functions as a correcting element and ensures that the beams are displaced in parallel such that, at least at the second collimator 3, the desired beam path and the mapping into the focal point 4 is present.

In FIG. 5, a first embodiment of an optical multi-coupler is shown. Optical sending elements 16 are mounted on a sending plate 17. The optical sending elements 16 each generate a divergent beam bundle, which is directed towards its own transmitting element 20, which is configured as a lens, in each case. From the transmitting element 20, the beam bundle is directed convergently towards the receiving plate 18 towards the respective receiving elements 19. The corresponding beam path is shown as a dotted line. It can be seen that, in the combination of sending element 16, transmitting element 20, and receiving element 19 shown in FIG. 5 below, a misalignment has occurred so that the transmitting element 20 does not map the beam bundle to the optical receiving element 19. Thus, according to the present invention, a correcting element 22, which is configured as a prism, is now positioned between the sending element 16 and the transmitting element 20 such that the course of the beam bundle is corrected so that it focuses on the optical receiving element 19, as presented by the solid lines.

In FIG. 6, a second embodiment of the multi-coupler according to the invention can be seen. This differs from the embodiment shown in FIG. 5 substantially in that the transmitting element consists of a first collimator 6 and a second collimator 3, respectively. The first collimator 6 is arranged together with the optical sending element 16 on the sending plate 17, while the second collimator 3 is arranged together with the optical receiving element 19 on the receiving plate 18. Again, the course of the beam bundle is shown schematically. A divergent beam bundle exits the optical sending elements 16 and is converted into a parallel beam bundle by the first collimators 6. Each optical sending element 16 is thus associated with a first collimator 6.

The parallel beam bundle then impinges on a second collimator 3, which converts the beam bundle into a convergent beam bundle, which is to be directed towards the associated optical receiving element 19.

Again, a misalignment has occurred in the bottom-most case, so that, as shown by the dashed line, the focal point lies outside of the optical receiving element 19. By providing a correcting element 23, the beam path is corrected and now impinges on the optical receiving element 19, as made clear by the solid line.

In FIG. 7a, an optical rotary transmitter of the prior art is shown. Three optical sending elements 16 and three optical receiving elements 19 are shown. The special feature of the rotary transmitter is that, for example, the optical receiving elements 19 rotate about a horizontal axis of rotation lying in the paper plane at the angular speed 2w. However, the optical sending elements 16 do not rotate. Despite the relative rotation between the receiving elements 19 and the sending elements 16, however, optical signals should be transmitted continuously from the sending elements 16 to the receiving elements 19. Thus, an optical transmitting element 24 is provided, which is made of a transparent material and has a refractive index different from ambient air. This is rotated about the same axis at half the rotation speed w. This ensures that the signal arrives at the receiving element in each position. In this application case of the optical multi-coupler, the exact positioning of both sending element and receiving element and transmitting element 24 is also important. Even the smallest misalignments cause the signal transmission to be interrupted.

According to the present invention, a correcting element 25 is therefore also provided here, as shown in FIG. 7b, which corrects any misalignment that may be present. With the correcting element configured as a prism, the beam path is displaced in parallel and impinges on the receiving element 19, which has not been correctly positioned in the embodiment shown.

FIGS. 8a and 8b show a demultiplexer as known from the prior art, in principle. Multiple fibre optics 26, three in the example shown, transmit an optical multiplex signal. The fibre optics 26 are supported on a focussing element 27. The focussing element 27 has curved surfaces that convert the divergent beam bundle exiting each fibre optic 26 into a parallel beam of light, which is schematically outlined in FIG. 8a. In the mirror plate 28, the parallel beams of light are reflected and impinge on the optical filters 29, each allowing a signal channel to be transmitted while all other signal channels are reflected. The reflected signal channels impinge on the mirror element 28 again and are directed to the next optical filter 29. As a result, each optical filter 29 passes through a signal channel, thereby separating the individual signal channels transmitted via a fibre optic 26. In the focus element 30, the parallel beam bundles are converted into convergent beam bundles and focused on the focal points 31, on which corresponding receiving elements are located.

In FIG. 8b, an enlargement of the focal points 31 is shown. It can be seen that two convergent beam bundles do not optimally impinge on the focal points 31. These are indicated with arrows.

According to the present invention, it is therefore provided that the exact position of the focal points is measured and then, if it does not match the desired position of the focal points, a corresponding correcting element is determined and produced. Such a correcting element is shown in FIG. 9. In fact, two correcting elements 33, 34 are applied to a correcting block 32. The correcting block 32 is then positioned where the parallel beam bundles are located, as can be seen in FIG. 10a. FIG. 10b again shows an enlargement of the corresponding optical receiving elements 31, and deviations are no longer present due to the correcting block 32.

The correcting element can consist of a prism, as already explained. In FIG. 11a, a corresponding prism 33 is shown. However, the correcting element can also have a cuboid cross-section and can consist of a main section 34 and a compensation section 35. The refractive indices of the main section 34 and the compensation section 35 differ. The entry surface 36 and the exit surface 37 are arranged parallel to one another.

FIGS. 12a to 12d schematically show how a correcting element or correcting component can be produced with multiple correcting elements.

First, a material consisting of a bearing plate 40, e.g. a glass plate, and a thermoplastic layer 41 arranged thereon is provided (FIG. 12a). Instead of the thermoplastic layer 41, any other material that becomes liquid or at least soft upon heating, such that it can be shaped using a punch, can be used. In addition, the material must be transparent for a beam bundle to be transmitted.

Next, as shown in FIG. 12b, a laser beam 42 is focused on a section of the thermoplastic layer 41. In the configuration shown, the laser beam is first passed through the bearing plate 40 and then into the thermoplastic layer 41. Furthermore, a punch 43 is provided, having a mould surface 46 configured as a negative to the surface of the correcting element to be produced.

The punch is then optionally inclined opposite a vertical on the surface of the thermoplastic coating 41 and then moved towards the thermoplastic layer 41 until approximately the position shown in FIG. 12c is reached.

With the laser beam 42, the thermoplastic coating 41 has become soft so that the punch 43 can penetrate into the thermoplastic layer 41. The laser beam 42 is then turned off so that the thermoplastic coating 41 cools again and becomes dimensionally stable. As soon as it is ensured that the thermoplastic layer 41 retains its shape, the punch 43 can be moved away from the material again.

Now, either the punch 43 or the material can be moved laterally and the heating step as well as the pressing-in step can be repeated at another position such that a plurality of correcting elements 44 are formed on the thermoplastic layer 41. The result is a correcting component 45 having multiple (in the example shown, three) correcting elements 44.

The individual correcting elements 44 can differ from one another by, for example, changing the angle that the punch 43 encloses with a vertical on the surface of the coating 41. Alternatively, other punches, such as the alternative punches 43′ and 43″ shown in FIG. 12c, which are equipped with differently shaped moulding surfaces 46′ and 46″, can also be used.

### LIST OF REFERENCE NUMBERS

1 Parallel beam bundle
2, 2′ Parallel beam bundle
3 Second collimator
4 Focal point
5 Focal point
6 First collimator
7 Position of the sending element
8 Position of the sending element
9 Focal point
10 Collimator
11 Focal point
12 Correcting element
13 Divergent beam bundle
14 Course of the divergent beam bundle
15 Glass plate
16 Optical sending elements
17 Sending plate
18 Receiving plate
19 Receiving element
20 Transmitting element
21 Transmitting element plate
22 Correcting element
23 Correcting element
24 Transmitting element
25 Correcting element
26 Fibre optic
27 Focussing element
28 Mirror plate
29 Optical filter
30 Focussing element
31 Focal points
32 Correcting block
33 Correcting element/Prism
34 Correcting element/Main section
35 Compensation section
36 Entry surface
37 Exit surface
40 Bearing plate
41 Thermoplastic layer
42 Laser beam
43, 43′, 43″ Punch
44 Correcting element
45 Correcting component
46, 46′, 46″ Mould surface

1. An optical multi-coupler, comprising:
a first group of optical sending elements and a second group of optical receiving elements,
wherein either the first group or the second group comprises more than two elements,
wherein each optical sending element is associated with a transmitting element, which is configured and arranged such that a divergent beam bundle emanating from the optical sending element is converted into a convergent beam bundle and diverted to an optical receiving element,
wherein the convergent beam bundle converges in a focal point, and
wherein a correcting element is positioned between an optical sending element and an optical receiving element and is configured such that:
i) the distance between the focal point and the optical receiving element is reduced by the correcting element,
ii) the angle at which the convergent beam bundle impinges on the optical receiving element is changed,
iii) the polarization state of the convergent beam bundle is changed, or
iv) the field shape of the convergent beam bundle is changed.

2. The optical multi-coupler according to claim 1, wherein the transmitting element comprises at least a first collimator and at least a second collimator,
wherein each optical sending element is associated with a first collimator, which is configured and arranged in such a way that the first collimator converts a divergent beam bundle emanating from the optical sending element into a parallel beam bundle, and each optical receiving element is associated with a second collimator, which is configured and arranged in such a way that a beam bundle directed from the first collimator to the second collimator is converted into a convergent beam bundle and diverted to the respective optical receiving element,
wherein the convergent beam bundle converges in a focal point, and
wherein a beam bundle exiting from an optical sending element is transmitted from the associated first collimator to one of the second collimators and diverted to the optical receiving element associated with the second collimator.

3. The optical multi-coupler according to claim 2, wherein multiple first collimators and/or multiple second collimators are joined together in a material-locking manner, and
wherein multiple first collimators and/or multiple second collimators are formed from one material piece.

4. The optical multi-coupler according to claim 2, wherein multiple first collimators and/or multiple second collimators are configured as curved reflective surfaces.

5. The optical multi-coupler according to claim 1, wherein the correcting element comprises an entry surface and an exit surface and is positioned between an optical sending element and an optical receiving element such that the beam bundle enters the correcting element via the entry surface and exits the correcting element via the exit surface.

6. The optical multi-coupler according to claim 5, wherein the correcting element is a prism.

7. The optical multi-coupler according to claim 6, wherein the entry surface of the prism and/or the exit surface of the prism are curved in configuration.

8. The optical multi-coupler according to claim 5, wherein the correcting element is a lens.

9. The optical multi-coupler according to claim 1, wherein the correcting element is arranged between a first collimator and a second collimator.

10. The optical multi-coupler according to claim 1, wherein the optical multi-coupler is configured as a multiplexer/demultiplexer.

11. The optical multi-coupler according to claim 1, wherein the optical multi-coupler is configured as an optical rotary transmitter.

12. The optical multi-coupler according to claim 5, wherein the correcting element comprises a main section and a subsequent compensation section,
wherein the main section comprises the entry surface and the compensation section comprises the exit surface,
wherein the main section consists of a material having a first refractive index and the compensation section consists of a material having a second refractive index, and
wherein the first and second refractive indexes are different.

13. The optical multi-coupler according to claim 12, wherein an interface between the main section and the compensation section is not configured parallel to the entry surface.

14. The optical multi-coupler according to claim 1, wherein a correcting component is provided, which comprises a plurality of correcting elements.

15. A method for producing an optical multi-coupler according to claim 1, comprising the following steps:
A) arranging
i) a first group of optical sending elements,
ii) a second group of optical receiving elements, wherein either the first group and/or the second group comprises more than two elements, and
iii) one or more transmitting elements,
so that
a) each optical sending element is associated with a transmitting element, and the transmitting element converts a divergent beam bundle originating from the optical sending element into a convergent beam bundle, and
b) the convergent beam bundle is diverted to an optical receiving element and the convergent beam bundle converges in a focal point;
B) emitting beam bundles from at least one sending elements of the group of optical sending elements;
C) sensing the position of the focal points of at least one of the one or more transmitting elements and/or sensing the direction of at least one of the converging beam bundles and/or sensing the polarization state of at least one of the converging beam bundles and/or sensing the field shape of at least one of the converging beam bundles;
D) determining and producing at least one correcting element with the proviso that, after positioning the correcting element at a predetermined position between the at least one sending element and a receiving element associated therewith, the difference between the value detected in step C) and a predetermined TARGET value is less than prior to the positioning of the correcting element; and
E) positioning the correcting element produced in step D) at the predetermined position.

16. The method according to claim 15, wherein at least a first collimator and at least a second collimator are used as the transmitting element, and
wherein:
a first collimator is associated with each optical sending element, and the first collimator converts a divergent beam bundle originating from the optical sending element into a parallel beam bundle,
each optical receiving element is associated with a second collimator, and a beam bundle directed from the first collimator to the second collimator is converted into a convergent beam bundle and diverted to the respective optical receiving element, and the convergent beam bundle converges in a focal point, and
a beam bundle exiting from an optical sending element is transmitted from the associated first collimator to one of the second collimators and diverted to the optical receiving element associated with this second collimator,
wherein, in step C), the position of the focal points of at least one of the second collimators and/or the direction of at least one of the converging beam bundles is sensed, and
wherein in step D), at least one correcting element is determined and produced with the proviso that, after positioning of the correcting element at a predetermined position between the at least one sending element and a receiving element associated therewith, the distance between the focal point of the second collimator associated with the receiving element and the receiving element is less than prior to the positioning of the correcting element and/or the deviation of the direction of the convergent beam bundle from a predetermined direction is less than prior to the positioning of the correcting element.

17. A method for producing a correcting element, comprising the following steps:
providing a base body from a transparent material for a beam bundle to be transmitted;
heating a surface of the base body until the surface is no longer dimensionally stable;
pressing a punch into the surface of the base body, said punch having a mould surface that is configured as the negative to a desired surface of the correcting element to be produced;
cooling the surface of the base body until the surface is dimensionally stable; and
bringing the mould surface out of engagement with the surface.

18. The method according to claim 15, wherein the correcting element is produced by a process including:
providing a base body from a transparent material for a beam bundle to be transmitted,
heating a surface of the base body until the surface is no longer dimensionally stable,
pressing a punch into the surface of the base body, said punch having a mould surface that is configured as the negative to a desired surface of the correcting element to be produced,
cooling the surface of the base body until the surface is dimensionally stable, and
bringing the mould surface out of engagement with the surface.

19. The optical multi-coupler according to claim 6, wherein the entry surface and the exit surface are not arranged parallel to one another.

20. The optical multi-coupler according to claim 13, wherein the exit surface is configured parallel to the entry surface.
